(19) United States
(12) Patent Application Publication
(10) Pub. No.: US 2021/0069978 A1
(43) Pub. Date: Mar. 11, 2021

(54) VAT FOR THREE-DIMENSIONAL MANUFACTURING APPARATUS AND THREE-DIMENSIONAL MANUFACTURING APPARATUS

(71) Applicant: KANTATSU CO., LTD., Tokyo (JP)

(72) Inventors: Eiji OSHIMA, Tokyo (JP); Kazutaka NOBORIMOTO, Tokyo (JP)

(21) Appl. No.: 16/919,586

(22) Filed: Jul. 2, 2020

(30) Foreign Application Priority Data
Jul. 3, 2019 (JP) 2019-124566

(51) Int. Cl. B29C 64/255; B33Y 30/00

(52) U.S. Cl. CPC B29C 64/255; B33Y 30/00

(57) ABSTRACT

The present invention provides a vat with a simple structure while achieving good releasability. A vat for a three-dimensional manufacturing apparatus includes a bottom surface of polymethylpentene, the bottom surface being integrally formed with the vat as a single piece.

### BACKGROUND OF THE INVENTION

### 1. Field of the Invention

The present invention relates to a vat for a three-dimensional manufacturing apparatus and a three-dimensional manufacturing apparatus.

### 2. Description of the Related Art

In the above technical field, JP 2017-159621 A discloses a stereolithographic tray (vat) to contact a photocurable material and provided with a release layer having a first resin, wherein the first resin is silicone rubber, nitrile rubber, or a tetrafluoroethylene unit.

The technique described in JP 2017-159621 A, however, has a resin, such as silicone rubber, arranged to cover a bottom surface and an inner wall of the tray (vat) to improve releasability of the cured material and the vat. The tray (vat) thus has a complex structure.

### SUMMARY

It is an object of the present invention to provide a technique to solve the above problems.

To achieve the above object, a vat for a three-dimensional manufacturing apparatus according to the present invention includes a bottom surface of polymethylpentene, the bottom surface being integrally formed with the vat as a single piece.

The present invention allows production of a vat with a simple structure while achieving good releasability.

### BRIEF DESCRIPTION OF THE DRAWINGS

FIG. 1A is a perspective view illustrating configuration of a vat for a three-dimensional manufacturing apparatus according to a first embodiment of the present invention.

FIG. 1B is a front view illustrating the configuration of the vat for a three-dimensional manufacturing apparatus according to the first embodiment of the present invention taken from a direction of an arrow in FIG. 1A.

FIG. 2 is a perspective view illustrating the entire configuration of a three-dimensional manufacturing apparatus including a vat for a three-dimensional manufacturing apparatus according to a second embodiment of the present invention.

FIG. 3 is a diagram illustrating production of a three-dimensional manufactured object by the three-dimensional manufacturing apparatus including the vat for a three-dimensional manufacturing apparatus according to the second embodiment of the present invention.

FIG. 4 is a perspective view illustrating configuration of the vat for a three-dimensional manufacturing apparatus according to the second embodiment of the present invention.

FIG. 5 is a chart illustrating heat resistance of polymethylpentene as a material for the vat for a three-dimensional manufacturing apparatus according to the second embodiment of the present invention.

FIG. 6 is a chart illustrating releasability of polymethylpentene as a material for the vat for a three-dimensional manufacturing apparatus according to the second embodiment of the present invention.

FIG. 7 is a chart illustrating transparency of polymethylpentene as a material for the vat for a three-dimensional manufacturing apparatus according to the second embodiment of the present invention.

### DETAILED DESCRIPTION OF THE PREFERRED EMBODIMENTS

Embodiments of the present invention are exemplarily described below in detail with reference to the drawings. It should be noted that the configuration, the numerical values, the process flows, the functional components, and the like described in the embodiments below are merely examples and may be freely modified or altered. The technical scope of the present invention is not intended to be limited to the following description.

### First Embodiment

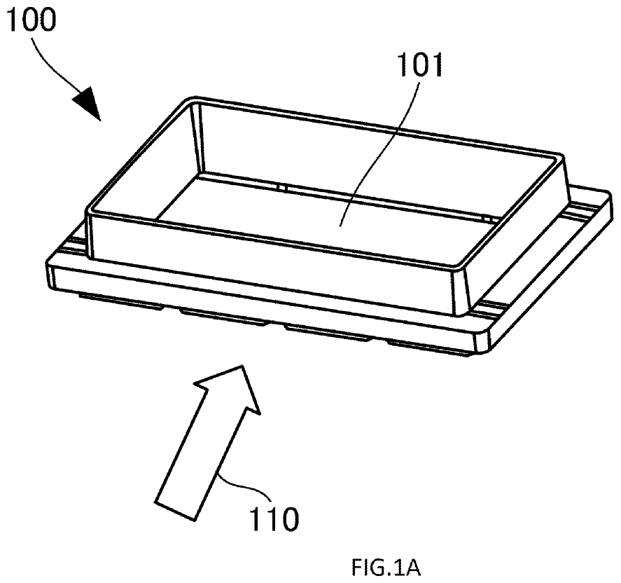

With reference to FIGS. 1A and 1B, a vat 100 for a three-dimensional manufacturing apparatus is described as the first embodiment of the present invention. FIG. 1A is a perspective view illustrating configuration of the vat for a three-dimensional manufacturing apparatus according to the present embodiment. FIG. 1B is a front view illustrating the configuration of the vat for a three-dimensional manufacturing apparatus according to the present embodiment taken from a direction of an arrow (110) in FIG. 1A. As illustrated in FIGS. 1A and 1B, the vat 100 for a three-dimensional manufacturing apparatus is a vat for a three-dimensional manufacturing apparatus including a bottom surface of polymethylpentene, the bottom surface being integrally formed with the vat as a single piece.

The present embodiment allows production of a vat with a simple structure.

### Second Embodiment

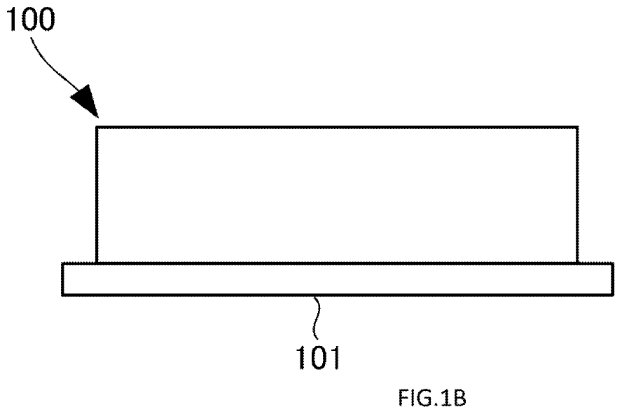

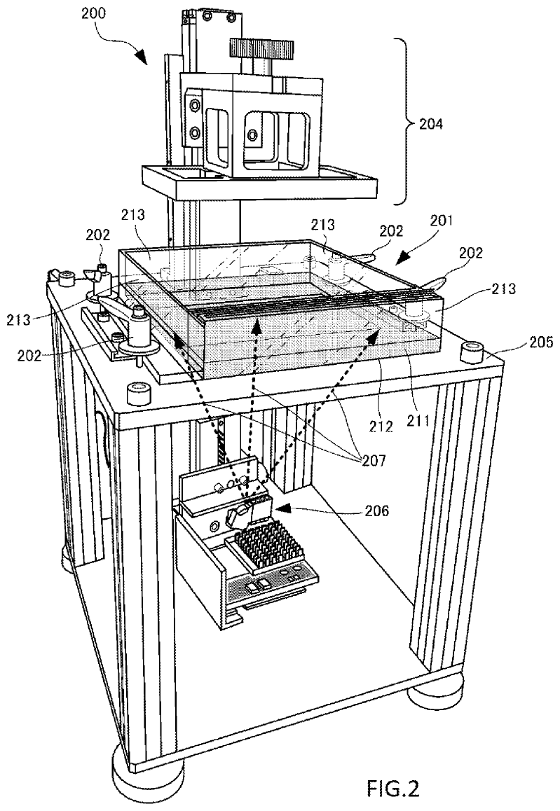

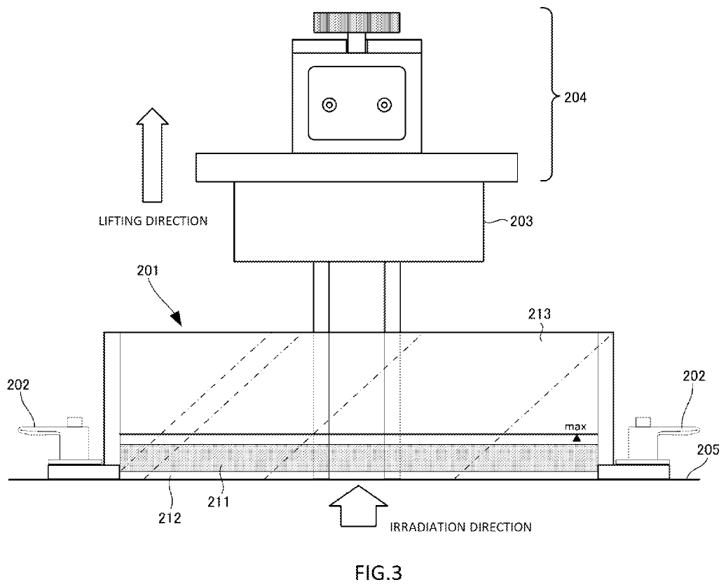

With reference to FIGS. 2 through 7, a three-dimensional manufacturing apparatus including a vat for a three-dimensional manufacturing apparatus according to the second embodiment of the present invention is then described. FIG. 2 is a perspective view illustrating the entire configuration of a three-dimensional manufacturing apparatus including a vat for a three-dimensional manufacturing apparatus according to the present embodiment. FIG. 3 is a diagram illustrating production of a three-dimensional manufactured object by the three-dimensional manufacturing apparatus including the vat for a three-dimensional manufacturing apparatus according to the present embodiment. FIG. 4 is a perspective view illustrating configuration of the vat for a three-dimensional manufacturing apparatus according to the present embodiment.

A three-dimensional manufacturing apparatus 200 has a vat 201, jigs 202, a platform 204, a manufacturing table 205, and an optical engine 206. The three-dimensional manufacturing apparatus 200 has dimensions of, but not limited to, a width of 250 mm×a depth of 291 mm×a height of 490 mm, for example.

The vat 201 contains a material 211 for a three-dimensional manufactured object 203. The material 211 is a photocurable resin and representative examples include ultraviolet curable resins, such as acrylic resins (polymeric acrylate), urethane resins (urethane acrylate), vinyl ester resins, and polyester-alkyd resins (epoxy acrylate). The material 211 is not limited to them as long as being a resin cured by irradiation with light.

With reference to FIG. 4, the vat 201 is a shallow quadrangular container in a box shape with a flat bottom of a transparent material, which facilitates checking an amount of the material 211 remaining therein. It should be noted that the vat 201 may be a deep container and it is possible to appropriately select a container with a depth and a base area in accordance with an amount of the material 211 to be contained.

The vat 201 has a bottom surface 212 of polymethylpentene (PMP) and is integrally formed with the bottom surface 212 as a single piece. Polymethylpentene is a synthetic resin belonging to thermoplastic resin as a type of polyolefin resins and is a thermoplastic polymer having 4-methyl-1-pentene as a main component.

The vat 201 has side surfaces 213, which may at least partially contain polymethylpentene. In other words, the vat 201 has the bottom surface 212 of polymethylpentene and may have side surfaces 213 at least partially containing polymethylpentene. Moreover, the entire vat 201 may be formed with polymethylpentene including the bottom surface 212 and the side surfaces 213.

The platform 204 is moved up and down by a platform feed mechanism and a stepping motor, not shown. The platform feed mechanism is a high rigidity ball screw feed mechanism. The stepping motor is a high torque stepping motor. It should be noted that the structure for moving up and down the platform 204 is not limited to the structure using the platform feed mechanism and the stepping motor. In addition, the platform feed mechanism is not limited to the ball screw feed mechanism.

The three-dimensional manufactured object 203 is manufactured by irradiating the material 211 contained in the vat 201 with light 207 from the optical engine 206 and lifting the platform 204 in a lifting direction. That is, the three-dimensional manufacturing apparatus 200 irradiates the material 211 with the light 207 from the optical engine 206 from below the vat 201. The three-dimensional manufacturing apparatus 200 then lifts the platform 204 to move upward, thereby lifting the three-dimensional manufactured object 203 per layer that is formed by curing the material 211 upon irradiation with the light 207. The three-dimensional manufacturing apparatus 200 repeats operation of curing the material 211 per layer and lifting the platform 204 a predetermined number of times to manufacture the three-dimensional additively manufactured object 203. The platform 204 is lifted at a pitch of, but not limited to, 2.5 μm (performs lamination of 2.5 μm).

The speed to lift the platform 204 is appropriately determined in accordance with the wavelength and intensity of the light 207, the type of the material 211, and the like. The platform 204 to manufacture the three-dimensional manufactured object 203 has dimensions of, but not limited to, 140 mm×80 mm, for example.

When the material 211 for one layer is cured by irradiation with the light 207 and one layer of the three-dimensional manufactured object 203 is formed, the platform 204 and the bottom surface 212 of the vat 201 are in a state of being adhered by the cured material 211. To manufacture next one layer of the three-dimensional manufactured object 203 in this state, the cured three-dimensional manufactured object 203 is peeled off from the bottom surface 212 for lifting the platform 204.

At this point, a strong force (stress) is exerted on the bottom surface 212, causing deformation, degradation, and the like in the case, for example, of the bottom surface of silicone rubber or the like as in JP 2017-159621 A. In addition, irradiation with the light 207 causes degradation of the bottom surface 212.

To cope with this situation, it is sometimes practiced that a light transmissive resin plate or a glass sheet is used as the bottom surface 212 of the vat 201 to attach a silicon resin plate with good releasability thereon. The silicon resin has a surface tension approximately from 2 to 3 mN/m, which is relatively low (water: approximately 70 mN/m), advantageous for peeling off of the three-dimensional manufactured object 203. However, repeated manufacture of the three-dimensional manufactured object causes repeated irradiation with the light 207 and exertion of the stress, leading to degradation (defect, whitening, etc.) of the silicon resin, and the vat thus has to be replaced after use for a certain period of time (has a short life). For example, use of a resin as the material 211 causes gas production due to heat generation by the irradiation with the light 207, and the silicon resin also appears degraded or seized. In addition, silicon resins are expensive and difficult to be integrally formed. Since the silicon resin is an elastomer and is soft and easily deformed, it causes difficulty in positioning and parallelization of the vat 201 and the platform 204.

In view of such a situation, the vat 201 in the present embodiment has the bottom surface 212 using polymethylpentene, which is excellent in releasability, light transmission, and heat resistance. In addition, the vat 201 may have the side surfaces 213 at least partially using polymethylpentene. Still in addition, the entire vat 201 may be formed with polymethylpentene. Polymethylpentene has a surface tension of approximately 24 mN/m or less, which is greater than that of the silicon resin but less than that of water (approx. 70 mN/m). It is thus considered that the stress by peeling off of the three-dimensional manufactured object does not affect much.

Moreover, since polymethylpentene is a material with good injection moldability, the entire vat 201 may be formed with polymethylpentene. Integral formation using polymethylpentene as a single piece allows the vat 201 to have improved rigidity and a simple structure. It is also possible to produce the vat 201 at low cost. Furthermore, polymethylpentene is also excellent in gas permeability and the produced gas is less likely to remain in the material 211 as bubbles, thereby allowing reduction in influence of the gas production due to the irradiation with the light 207 and manufacture of the three-dimensional manufactured object 203 of high quality.

One of the properties of polymethylpentene is markedly high oxygen permeability (1400 cm³·mm/m²·24 hr/atm) compared with other materials. Due to the high oxygen permeability, oxygen is supplied to the surface of the photocurable resin to inhibit curing of the photocurable resin at the boundary between the vat and the three-dimensional manufactured object formed on the platform. This improves the releasability of the three-dimensional manufactured object formed on the platform from the vat, and as a result, improves the rate and precision of manufacturing the three-dimensional manufactured object and the durability of the apparatus.

The manufacturing table 205 detachably supports the vat 201. The vat 201 is attached to the manufacturing table 205 with the jigs 202 for attachment. The vat 201 is fixed to the manufacturing table 205 by fastening the jigs 202 and the vat 201 is removed from the manufacturing table 205 by unfastening the jigs 202.

The optical engine 206 is a high-power precise engine. The light 207 emitted from the optical engine 206 has a wavelength of 405 nm while the wavelength of the light 207 may be, but not limited to, from 200 nm to 400 nm. The light 207 emitted from the optical engine 206 is focus free.

Although detailed configuration of the optical engine 206 is not shown, the optical engine 206 has a light source, a reflecting mirror, a photodetector, a two-dimensional micro electro mechanical systems (MEMS) mirror, and the like. The light source has a semiconductor laser diode (LD), a collimator lens, and the like. The semiconductor LD is a laser oscillator element to oscillate an ultraviolet laser beam and the like. It should be noted that the laser oscillator element is not limited to such a semiconductor LD and may be a light emitting diode (LED). The two-dimensional MEMS mirror is a mirror driven based on a control signal input from outside and a device that vibrates to reflect the laser beam by varying the angle in the horizontal direction (X direction) and the vertical direction (Y direction). The optical engine 206 has a resolution of 720 P or 1080 P, a width of approximately 30 mm, a depth of approximately 15 mm, a height of approximately 7 mm, and a volume of approximately 3 cc. One or a plurality of semiconductor LDs may be arranged in the optical engine 206 and a necessary number of semiconductor LDs may be placed arranged in accordance with the application purpose. Although the light 207 emitted from the optical engine 206 has a spot size of, for example, 75 μm, the spot size may be appropriately changed in accordance with the application purpose.

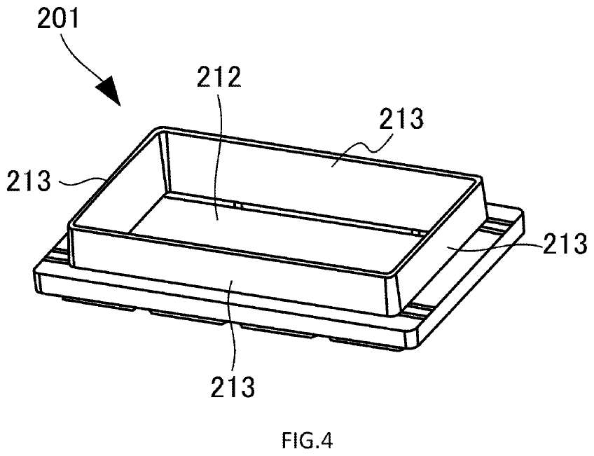

FIG. 5 is a chart illustrating heat resistance of polymethylpentene as a material for the vat 201 for a three-dimensional manufacturing apparatus according to the present embodiment. In a graph 500, the abscissa represents the temperature and the ordinate represents the strength. The reference numeral 501 represents polymethylpentene (PMP), 502 represents polycarbonate, 503 represents a propylene copolymer, and 504 represents low density polyethylene. Since polymethylpentene has a melting point from 220° C. to 240° C. and a high Vicat softening temperature (VST), it is excellent in heat resistance.

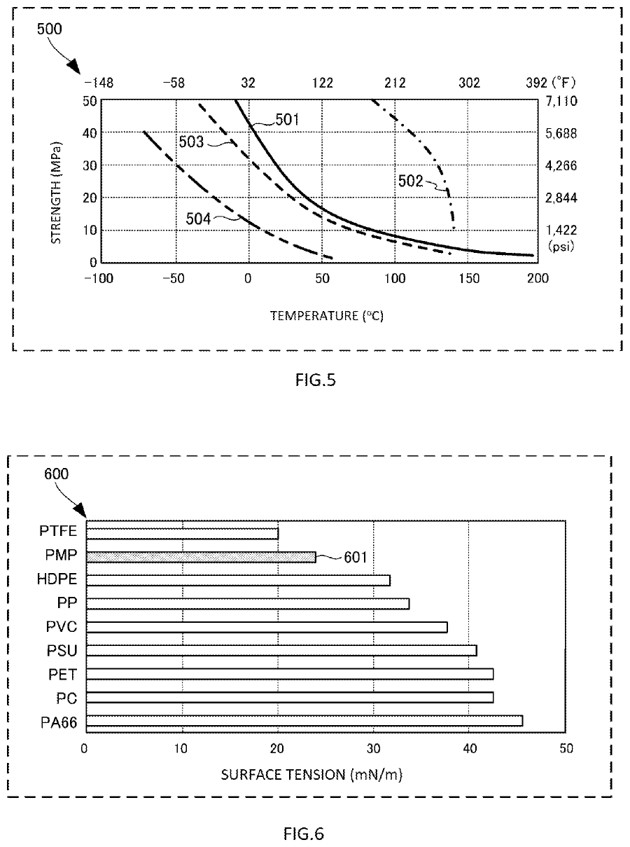

FIG. 6 is a chart illustrating releasability of polymethylpentene as a material for the vat 201 for a three-dimensional manufacturing apparatus according to the present embodiment. In a graph 600, the abscissa represents the surface tension (mN/m) and the ordinate represents resins. The ordinate represents, from the top, polytetrafluoroethylene (PTFE: 20 mN/m), polymethylpentene (PMP: 24 mN/m), high density polyethylene (HDPE: 32 mN/m), polypropylene (PP: 34 mN/m), polyvinyl chloride (PVC: 38 mN/m), polysulfone (PSU: 41 mN/m), polyethylene terephthalate (PET: 43 mN/m), polycarbonate (PC: 43 mN/m), and polyamide 66 (PA66: 46 mN/m). It should be noted that the numerical values in the parentheses indicate surface tensions.

It is understood that polymethylpentene (601) used in the present embodiment has a low surface tension (24 mN/nn) compared with other resins and has high releasability and releasability. The vat 201 is formed using polymethylpentene having high releasability and releasability in the present embodiment, it is thus possible to set the pitch to lift the platform 204 at, for example, 1.0 μm. In addition, due to the high releasability, polymethylpentene allows high speed manufacture of the three-dimensional manufactured object 203. Still in addition, the high releasability and the small coefficient of friction of polymethylpentene improves slipping of the vat 201 and facilitates taking in and out of the vat 201. Moreover, polymethylpentene has good releasability and releasability, not likely to cause adherents and facilitating maintenance and handling.

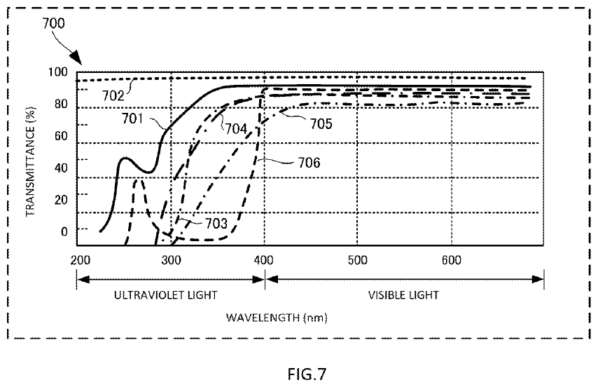

FIG. 7 is a chart illustrating transparency of polymethylpentene as a material for the vat 201 for a three-dimensional manufacturing apparatus according to the present embodiment. In a graph 700, the abscissa represents the frequency (visible light, ultraviolet light) and the ordinate represents the transmittance. The reference numeral 701 represents polymethylpentene, 702 represents quartz, 703 represents glass, 704 represents polystyrene (PS), 705 represents polyvinyl chloride (PVC), and 706 represents a polymethyl methacrylate resin. It is understood that polymethylpentene (701) has high transparency and high light transmission at wavelengths around 405 nm. Since polymethylpentene has high light transmission at wavelengths around 405 nm, it is possible to manufacture the three-dimensional manufactured object 203 with high precision for manufacture using the wavelength.

According to the present embodiment, the bottom surface of the vat has good releasability and thus a release layer does not have to be separately provided. In addition, integral formation of the entire vat including the bottom surface and other areas of the vat with polymethylpentene as a single piece allows formation of the vat excellent in releasability, light transmission, and heat resistance. The integral formation of the entire vat with polymethylpentene as a single piece also allows an increase in the amount of oxygen intake and thus even more improvement in the releasability and the durability of the vat and the precision and the rate of manufacturing the three-dimensional manufactured object. The rigidity of the vat is also improved and the structure of the vat is simplified to allow large reduction in the production cost of the vat. Still in addition, the vat produced with polymethylpentene has high transmittance of light at 405 nm and thus allows manufacture with high precision. It also facilitates replacement of the material contained in the vat. Moreover, it is possible to produce the vat inexpensively, cost bearing is reduced in the case of preparing a plurality of vats for different types of material. Since the material is allowed to be contained without the operation of attaching a silicon resin or the like on the bottom surface of the vat to improve the releasability with the manufactured object, the handling is facilitated very much. Since the integrally formed vat has a rigid structure including the bottom surface, it is possible to readily perform positioning and parallelization with the platform.

### OTHER EMBODIMENTS

While the present invention has been described with reference to the above embodiments, the present invention is not limited to these embodiments. Various modifications understood by those skilled in the art may be made to the present invention in the configuration and details withing the scope of the present invention. In addition, the scope of the present invention also includes all systems and devices that are made by any combination of separate characteristics included in the respective embodiments.

Still in addition, the present invention may be applied to a system configured from a plurality of devices or may be applied to a single device. Moreover, the present invention is also applicable to the case of supplying an information processing program to achieve the functions in embodiments to the system or the device to be executed by a built-in processor. Accordingly, the scope of the present invention also includes a program installed in a computer to achieve the functions of the present invention by the computer, a medium having the program stored therein, a WWW (world wide web) server to download the program, and the processor to execute the program. In particular, the scope of the present invention includes at least a non-transitory computer readable medium having a program causing a computer to execute the processing steps included in the above embodiments.

1. A vat for a three-dimensional manufacturing apparatus comprising a bottom surface of polymethylpentene, the bottom surface being integrally formed with the vat as a single piece.

2. The vat for a three-dimensional manufacturing apparatus according to claim 1, further comprising a side surface at least partially containing polymethylpentene.

3. The vat for a three-dimensional manufacturing apparatus according to claim 2, wherein the entire vat including the bottom surface and the side surface is formed with polymethylpentene.

4. A three-dimensional manufacturing apparatus, comprising:
the vat according to claim 1;
a manufacturing table detachably supporting the vat;
a light source configured to irradiate a material contained in the vat with light from below; and
a platform configured to lift a manufactured object per layer, the manufactured object being formed by curing the material upon irradiation with the light.

5. A three-dimensional manufacturing apparatus, comprising:
the vat according to claim 2;
a manufacturing table detachably supporting the vat;
a light source configured to irradiate a material contained in the vat with light from below; and
a platform configured to lift a manufactured object per layer, the manufactured object being formed by curing the material upon irradiation with the light.

6. A three-dimensional manufacturing apparatus, comprising:
the vat according to claim 3;
a manufacturing table detachably supporting the vat;
a light source configured to irradiate a material contained in the vat with light from below; and
a platform configured to lift a manufactured object per layer, the manufactured object being formed by curing the material upon irradiation with the light.
